(19) United States
(12) Patent Application Publication
(10) Pub. No.: US 2003/0009921 A1
(43) Pub. Date: Jan. 16, 2003

(54) Static cling loops

(76) Inventor: Robert J. McAllister, Solana Beach, CA (US)

Correspondence Address: THE MAXHAM FIRM, 750 "B" STREET, SUITE 3100, SAN DIEGO, CA, 92101, US

(21) Appl. No.: 09/903,123

(22) Filed: Jul. 10, 2001

(51) Int. Cl. G09F 3/10

(52) U.S. Cl. 40/299.01

(57) ABSTRACT

A unitary, elongated strip of static cling material such that a portion of the inner and outer surface engage to from a loop. Various indicia may be printed by known methods provided that a smooth overlapping surface is maintained. The outer surface may be coated with a sulfur-based ink, producing a glow-in-the-dark feature. Materials used may be hypoallergenic and FDA approved.

### BACKGROUND OF THE INVENTION

1. Field of the Invention

The present invention relates generally to closed loops such as identification tags and toy bracelets, and more particularly to reusable static cling loops, available for a wide range of uses, and which may be custom printed.

2. Discussion of Related Art

Static cling materials are not a new concept in and of themselves. However, these materials are not known in the area of bracelets or identification tags, or for temporarily securing objects together or holding a bag closed. Areas in which static cling technology is known include decoration and education, such as placing a small item of static cling material on another, generally larger, smooth surface such as billboards, signs, cards, and window dressings. Patents such as Static Cling Banner, U.S. Pat. No. 5,899,010, and Static Cling Greeting Card, U.S. Pat. No. 5,914,158, disclose two such examples. A sign/banner system that combines a static cling vinyl to a second plastic sheet to create an inexpensive, temporary sign or banner is shown in the '010 patent. The greeting card patent applies the same techniques to greeting cards. Like the '010 patent, the '158 patent requires both a static cling material as well as a nonporous smooth surface as a base element.

Security bracelets, such as shown in U.S. Pat. No. 5,799,426, are known in the industry. These use an adhesive to combine the ends of a thin, flexible, elongated strip. Such bracelets are commonly used in local fairs and amusement parks to identify those patrons who have paid, and further, to restrict transferring the bracelet from one person to another. Others employ a non-removable snap fastener. These bracelets cannot be removed without causing damage to the bracelet itself. The security measure of the '426 patent reveals whether the bracelet has been removed or changed hands. Inherent to its design is that these devices are used only once. In situations where the bracelets would serve as identification rather than security, this recurring expense is a drawback.

### SUMMARY OF THE INVENTION

It is the primary purpose of the present invention to provide a static cling loop which is reusable, self-sticking without using an adhesive coating, able to accept custom images generated from a laser or ink jet printer for example, and may be available in fluorescent or glow-in-the-dark covering.

A bracelet made according to the invention can be used for recurring events such as annual meetings, family reunions, and children's parties, or just as a decorative accent when used as a child's bracelet. A customized static cling bracelet of this invention can be produced to aid in identification or it can be used as an icebreaker in a mixer or other type of party. Each bracelet can have an individual's name and possibly hometown or some distinctive fact. Since the bracelets are re-usable, the bracelets may be collected after each use, washed, and restored to their original condition. Also, because the bracelets do not employ an adhesive, they will never stick to the user's skin, hair, or clothing.

Children can use the loops of this invention as decorative bracelets when festive images are applied to the outer surface. These bracelets can also be used as a means of identifying an individual or an entire group such as the members of a children's birthday party at a commercial establishment where there may be several groups of unrelated people. Applying a unique color or numbering to each bracelet creates a safer environment by providing a quick means of identifying who does and who does not belong at a particular party or function. Bracelets can also be used as a safety device when treated with a sulfur-based ink to produce a glow-in-the-dark effect for events that occur at night such as trick-or-treating on Halloween. Loops of static cling strips can be used for many purposes in accordance with the invention, other than as bracelets.

### BRIEF DESCRIPTION OF THE DRAWING

The above and other objects, advantages and features of the present invention will be more readily apparent from the following detailed description, when read in conjunction with the accompanying drawing, wherein:

FIG. 1 is a front view of a variety of static cling bracelets, each with its own unique design in accordance with the invention;

FIG. 2 is a front view of bracelets of the invention being used to display a type of information about the users;

FIG. 3 is a side view of a loop according to the invention, demonstrating how the ends overlap to form an engaging closed loop; and

FIG. 4 is a perspective view of various possible uses of the static cling loops of the invention.

### DETAILED DESCRIPTION OF THE PREFERRED EMBODIMENTS

The term “static cling” as used throughout this disclosure refers to the common effect describing the electromagnetic relationship observed between two items, at least one of which is charged by static electricity. No implication is here made as to whether the force that causes static cling in only an attractive force due to static electricity. Other forces, in fact, may contribute to the overall adhesion of one material to another that is generally referred to as static cling. A “static cling material” is a material particularly known to produce a static cling effect. This invention employs the static cling effect in novel ways. No claim is made to a novel material, which exhibits the static cling effect.

The static cling effect is employed in the invention by forming a loop of a strip of static cling material, where the strip readily engages and adheres to itself. A radial tugging from inside the loop results in it holding fast because the shear strengths of the two mating static cling surfaces are high. However, the loop is easily disengaged by peeling one end from the other. There is substantially no resistance to such peeling away and there is no residual tendency for the strip to stick to anything else or to re-stick to itself. The strip may be about 0.01 mm to about 0.50 mm in thickness.

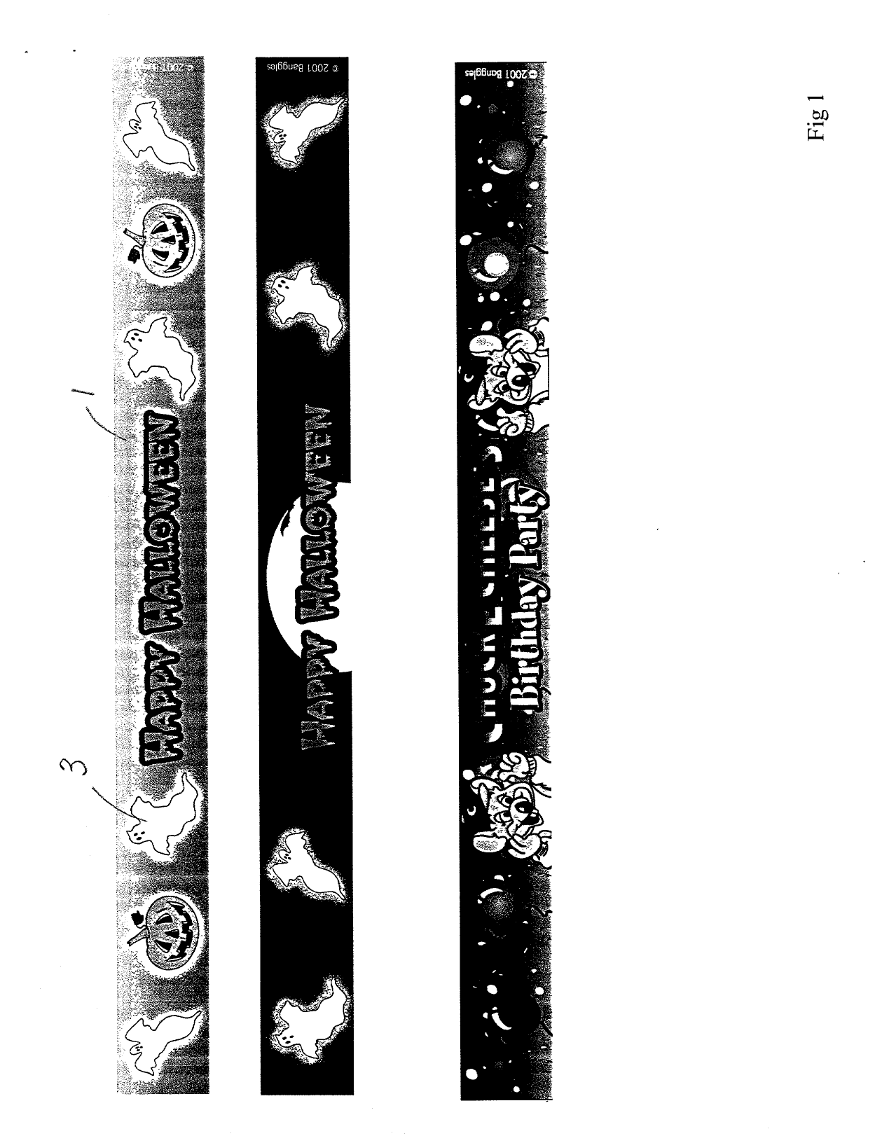

Strips of static cling materials have a variety of uses in accordance with the invention. Although the main focus of this device is to provide a distinctive bracelet for safety, decorative, and identification purposes, the device can easily be adapted for several additional uses. Static cling loops, according to the invention, may selectively be used to bind papers or file folders together or in a closed condition. It may be employed, as an easily disengage able strip, in place of a rubber band, for temporary securing purpose. It may be used to temporarily bind a bag closed. It may be used to bind the pant leg of a person riding on a bicycle so that the pant leg does not get caught in the chain. FIG. 1 is a front view of strips of static cling materials 1 with various decorative images 3 printed on the outer face of each strip. This embodiment demonstrates the device as a decoration or child's toy bracelet. When treated with sulfur-based ink, strips of static cling materials also provide security to children playing outside at night. These glowing, re-useable strips will tell near-by drivers to stay alert, that children are near. Loops according to the invention may have any desired printing, graphics or other indicia printed on them, or they may only be of a solid color or striped, or may have any kind of geometric or color design.

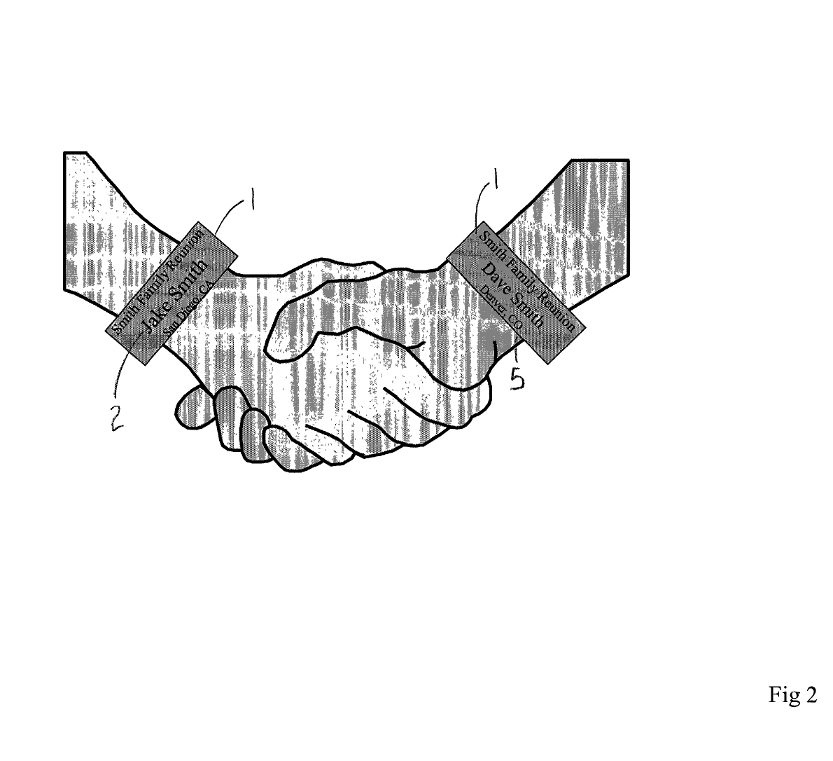

FIG. 2 shows strips of static cling materials 1 being used as informative bracelets. Custom lettering 2 in this instance concerns a family reunion. Any type or amount of indicia 2 may be printed on the band's exterior surface. Because strips of static cling materials are reusable, they will be ideal for recurring meetings and parties. Recurring cost of creating identification tags is reduced or unnecessary when using strips of static cling materials 1. These bands may be washed and stored until the next meeting or party. Also, strips of static cling materials will never stick to the user's skin because the inner surface 5 does not require an adhesive and it does not stick to other than itself or another smooth surface.

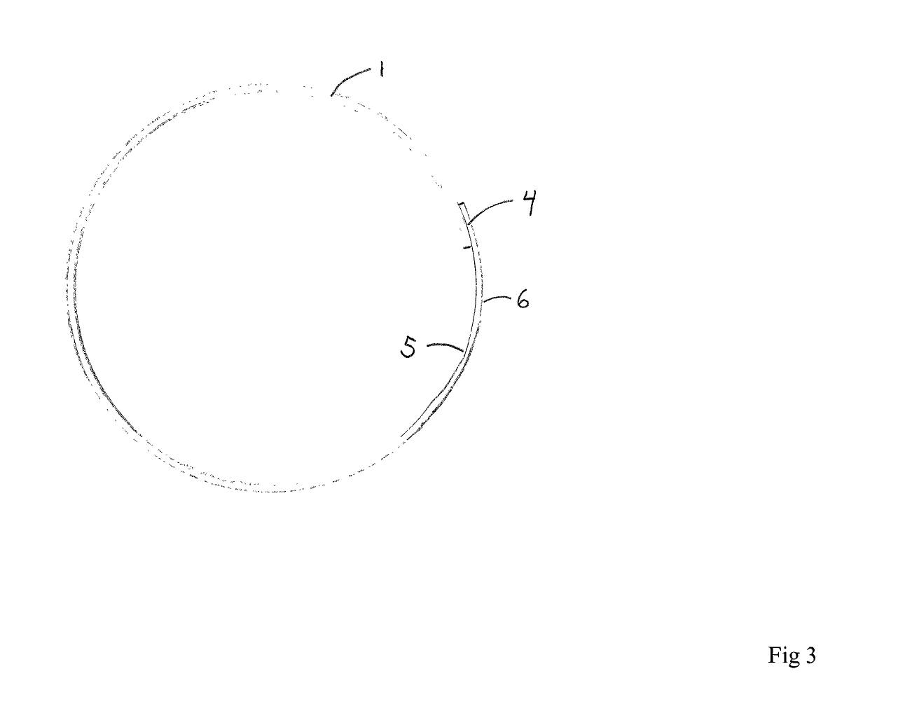

FIG. 3 is a side view of the loop that is created when overlaying the ends of strips of static cling materials 1. A connection 4 is established whenever an inner surface 5 and outer surface 6 are overlapped and laid against each other. The connected surface can be substantially less than ½ inch and still maintain a connection 4 sufficient for daily use.

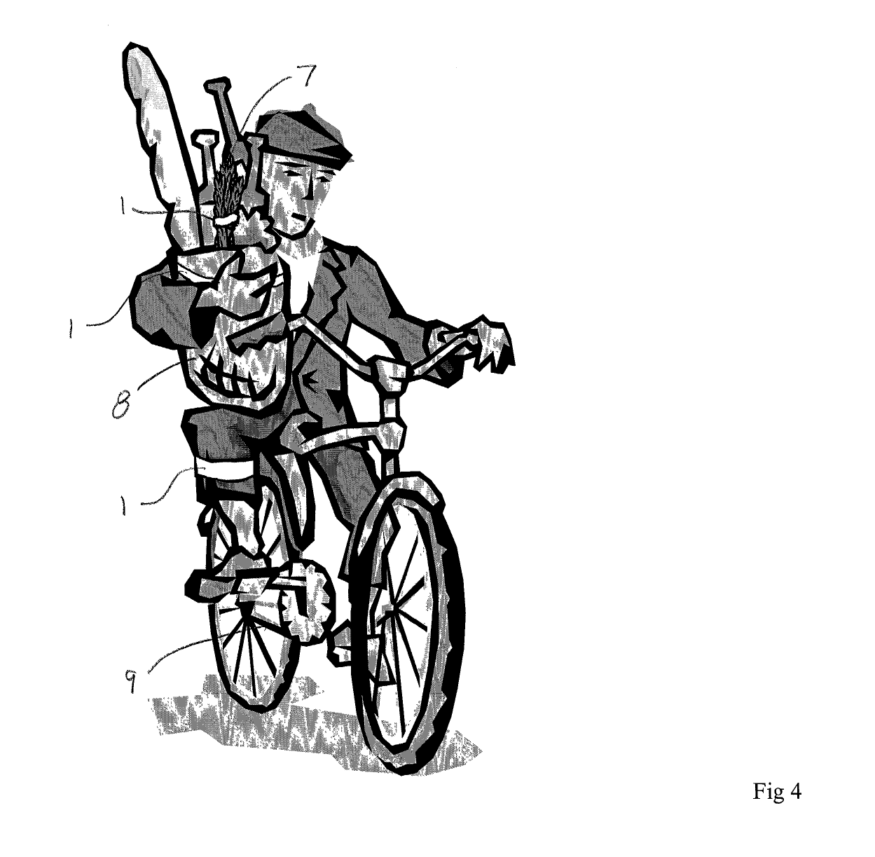

FIG. 4 is a perspective view of a few potential uses of strips of static cling materials 1. Strips of static cling materials may be formed of FDA approved materials, suitable for binding certain produce such as a bunch of asparagus 7. Additionally, a long strip of static cling materials may be used to close a grocery bag 8 or keep a pant leg from being caught in a bicycle chain 9 while the user is in transit.

While the present invention has been illustrated and described by means of specific embodiments and alternatives, it is to be understood that numerous changes and modifications can be made without departing from the spirit and scope of the invention. Therefore, it should be understood that the invention is not to be limited in any way except in accordance with the appended claims and their equivalents.

What is claimed is:

1. A device made of static cling material, said device comprising:
an elongated strip having predetermined indicia on at least one side thereof, the surfaces of said strip being smooth;
said strip being securable to itself when the ends thereof are overlapped and placed into mutual surface contact to form a loop, the contacting surfaces having a strong resistance to shear and being readily peelable from each other.

2. The static cling device of claim 1, wherein material thickness may range from about 0.01 millimeter to about 0.50 millimeter.

3. The static cling device of claim 1, wherein outer surface is printed with a sulfur-based ink, producing a glow-in-the-dark feature.

4. The static cling device of claim 1, wherein said materials are hypoallergenic.

5. The static cling, device of claim 1, wherein a removable release sheet is overlayed on one surface of said strip.

6. A unitary static cling device comprising:
an elongated strip having an inner and outer surface;
said outer surface comprising a flexible, non-porous, plastic material;
said inner surface comprising a smooth flexible, non-porous material surface;
said elongated strip being self adhering such that when a portion of its ends overlap and said inner surface and said outer surface overlay each other they form a static cling connection.

7. The device of claim 6, wherein said elongated strip having predetermined indicia printed on one side thereof.

8. The device of claim 7, wherein said one side is printed with a sulfur-based ink, producing a glow-in-the-dark feature.

9. The device of claim 7, wherein said materials are hypoallergenic.

10. The device of claim 6, wherein a removable release sheet is overlayed on one surface of said strip.
